(19) United States
(12) Patent Application Publication
(10) Pub. No.: US 2012/0198541 A1
(43) Pub. Date: Aug. 2, 2012

(54) METHODS AND APPARATUS FOR PREVENTING NETWORK INTRUSION

(76) Inventor: Randall E. Reeves, Farmington Hills, MI (US)

(21) Appl. No.: 13/019,618

(22) Filed: Feb. 2, 2011

(51) Int. Cl. G06F 21/00; G06F 15/177

(52) U.S. Cl. 726/13; 713/1

(57) ABSTRACT

In one configuration, a non-volatile memory is provided having computer readable instructions configured to instruct a computer or controller to run a setup wizard to obtain setup and filtering module configuration rules from a user; reload the computer or controller with the settings obtained by the setup wizard; configure filtering module rules including rules for an industrial protocol filter; and filter received and/or transmitted packets in accordance with the filtering module rules. The configuration may also include instructions to further parse and analyze packets containing industrial protocols to determine whether to allow or deny ingress and/or egress of such packets.

### BACKGROUND OF THE INVENTION

The present invention is directed to methods and apparatus for filtering communication protocols to prevent network intrusion.

Deep Packet Inspection (DPI) for anti-intrusion security combines the functionality of an Intrusion Detection System (IDS) and an Intrusion Prevention System (IPS) with a traditional stateful firewall. This combination makes it possible to detect certain attacks that neither the IDS/IPS nor the stateful firewall can catch on their own. However, stateful firewalls, which can detect the beginning and end of a packet flow, cannot, on their own, detect events that would be out of bounds for a particular application. While IDSs are able to detect intrusions, they have very little capability to block such an attack. DPIs can be used to prevent attacks from viruses and worms at wire speeds. More specifically, DPI can be effective against buffer overflow attacks, Denial of Service (DoS) attacks, sophisticated intrusions, and a small percentage of worms that fit within a single packet. However, a greater level of security control is required for complex industrial networks.

Intrusion Detection and Intrusion Prevention Systems (IDS/IPS) normally rely on signature comparisons such as the SNORT program maintained by Sourcefire. Most security vendors use some variation of this program modified for their specific product offering.

SNORT, an intrusion detection and intrusion prevention product, has been used in products that can interpret industrial protocols and do a signature-based comparison on a portion of a data stream. However, a problem arises because programs like SNORT do not convert the data stream into meaningful data. Rather, tests indicate that signature based systems are, at best, about 30% accurate in detecting attack vectors. The tests produced large numbers of false positives and false negatives. The present inventor believes that this inaccuracy is a result of the difficulty of accurately performing a bit set comparison against an industrial protocol.

At least one vendor, Digital Bond, is known to supply a product that compares a known signature to multiple packets that have been parsed and reassembled for comparison. However, some objects within, for example, CIP (Common Industrial Protocol) have multiple embedded objects, and thus cannot be properly analyzed by a signature comparison even with the use of protocol specific preprocessors. False positive and false negative detections of threats and intrusions occur in numbers that may be unacceptable in some industrial automation and critical infrastructure systems.

Industrial automation and critical infrastructure can include plant automation on the plant floor, pipeline, power plants, power distribution, water, waste water, formalized science manufacturing, food manufacturing and packaging, mining, minerals, and cement. All of these and others fall within the spectrum of industrial automation in critical infrastructure, so this list is not intended to be complete or all inclusive. The production of a physical product, or a tangible product like electricity, is also considered to fall within industrial automation and/or critical infrastructure. A common feature of this infrastructure is that, on the plant floor, programmable logic controllers (PLCs) control robots. Most of these PLCs can be held in one's hand and are typically programmed using ladder logic. PLCs can be programmed by industrial engineers.

There are many manufacturers, such as Alan Bradley, GE, Coryell, Emerson, ABB, Siemens, etc., that build these PLC controllers. In one plant, step one of a ladder logic program may be, for example, to raise a robot arm 17.2° in 1.3 seconds and then to rotate the hand 63° in 3.2 seconds. This logic cascades down, as control passes to a next logic controller, which, for example, may swing an entire robot assembly around. Additional logic controllers may perform other steps in sequence down an assembly line. Down the line further, another logic controller may write data to a logic controller in the assembly line to make that logic controller speed up or slow down due to the number of manufactured items coming through the assembly line. Other devices, such as process servers, control processes that are very high speed or which may utilize numerous variables. Other devices found on a plant floor can include HMIs, which are human-machine interfaces such as display screens that allow a process engineer to see that a process is running properly and to enter data to change something.

At one time, all process controllers ran on proprietary protocols. For example, some process controllers used a serial driven protocol with proprietary hardware. Thus, the controllers had unique electrical connectors that were proprietary to the individual manufacturers, and the whole control loop, including the process controllers, was completely isolated. Management need for efficiency and ERP data was handled by floor operators using manual paper and pencil techniques. However, these techniques became inadequate as real-time efficiency measurements, inventory numbers, and supplier delivery orders based on supplier lead times were desired. Furthermore, CEOs wanted to know why, for example, their company's plant in India operated at high efficiency except on Tuesdays while their plant in Malaysia operated in high efficiency except every fourth Wednesday of the month.

A solution to these data needs was to converge real-time data from different locations on to Ethernet. One such protocol is known as CIP, the common industrial protocol. Another such protocol is known as PROFINET. DNP3 is a master-slave serial protocol used predominantly in chemical plants, in power substations and in power plants. For example, a DNP3 protocol can be used to shut off or turn on breakers and/or motors.

At a higher level, the ICCP (inter control center protocol) is used to provide communication between electrical grids. Another protocol known as OPC is an open source standard interpretive language that can be used for communication between a plant floor and a database server. This language allows transformation of data sets between different protocols.

The use of such diverse protocols can lead to the vulnerability of industrial plants. For example, the Stuxnet worm, which many believe will be adapted from a vector spread by a USB key to possibly server side scripts or e-mail, and change protocol from, for example, PROFINET to CIP so that it is able to attack other types of controllers.

The security of critical infrastructure has become such a major concern that the NSA, the Department of Homeland Security, and the Department of Defense have their own laboratories, and are now are under a directive by presidential order to implement various security measures.

### BRIEF DESCRIPTION OF THE INVENTION

In one aspect, some embodiments of the present invention provide a non-volatile memory having computer readable instructions configured to instruct a computer or controller to run a setup wizard to obtain setup and filtering module configuration rules from a user; reload the computer or controller with the settings obtained by the setup wizard; configure filtering module rules including rules for an industrial protocol filter; and filter received and/or transmitted packets in accordance with the filtering module rules. The configuration may also include instructions to further parse and analyze packets containing industrial protocols to determine whether to allow or deny ingress and/or egress of such packets.

In another aspect, some embodiments of the present invention provide a method of operating an industrial plant that includes a plurality of industrial controllers on a local area network (LAN). The method includes providing an anti-intrusion and security apparatus (AISA) having two or more Ethernet ports, one of which is configured to communicate through a wide area network (WAN), and the other of which is configured to communicate with the LAN. The method further includes electrically connecting the first Ethernet port to the WAN and the other Ethernet port to the LAN. The method also includes utilizing the AISA to filter packets of data received for ingress at the first Ethernet port in accordance with one or more rules and utilizing the AISA to filter packets of data received for egress at the other Ethernet port in accordance with one or more rules. At least one of filtering packets of data received for ingress, filtering packets of data received for egress, or both, further include utilizing the AISA to analyze objects embedded in industrial protocol filter connections to determine whether or not to drop the packet.

In yet another aspect, some embodiments of the present invention provide an anti-intrusion and security apparatus (AISA) that includes a microprocessor or controller (hereinafter, “microprocessor”), memory communicatively associated with the microprocessor, one or more filtering modules, not necessarily separate from the memory and the microprocessor and at least one WAN port interface and a LAN port interface having communication therebetween controlled by the filtering module. The AISA is configured to run a setup wizard to obtain setup and filtering module configuration rules from a user, reload the memory with the settings obtained by the setup wizard, configure filtering module rules in the memory including rules for an industrial protocol filter, and filter received packets for communication ingress and egress in accordance with the filtering module rules.

It will thus be appreciated that embodiments of the present invention provide increased security in industrial plants and protection against the various types of malware that could otherwise be introduced into the plant deliberately or accidently. It will also be appreciated that embodiments of the present invention are not limited to use in industrial plants, but can be used in other systems in which network security is to be provided.

### BRIEF DESCRIPTION OF THE DRAWINGS

FIG. 1 is a pictorial diagram of one embodiment of an AISA.

FIG. 2 is a functional block diagram of the AISA of FIG. 1.

FIG. 3 is a block diagram of an industrial plant communicatively coupled to the Internet using the AISA of FIG. 1.

FIG. 4 is a drawing of an introductory screen of a setup wizard provided by the AISA of FIG. 1.

FIG. 5 is a drawing of an AISA general parameter setup screen.

FIG. 6 is a drawing of an AISA date and time setup screen.

FIG. 7 is a drawing of a WAN interface type setup screen.

FIG. 8 is a drawing of another WAN setup screen.

FIG. 9 is a drawing of an IP address and gateway setup screen.

FIG. 10 is a drawing of a DHCP hostname setup screen.

FIG. 11 is a drawing of a PPPoE general parameter setup screen.

FIG. 12 is a drawing of a setup screen that is used to block or unblock RFC1918 private networks and/or bogon networks.

FIG. 13 is a drawing of a LAN interface setup screen.

FIG. 14 is a drawing of a filtering module setup screen to set the maximum number of connections to hold in a filtering module state table.

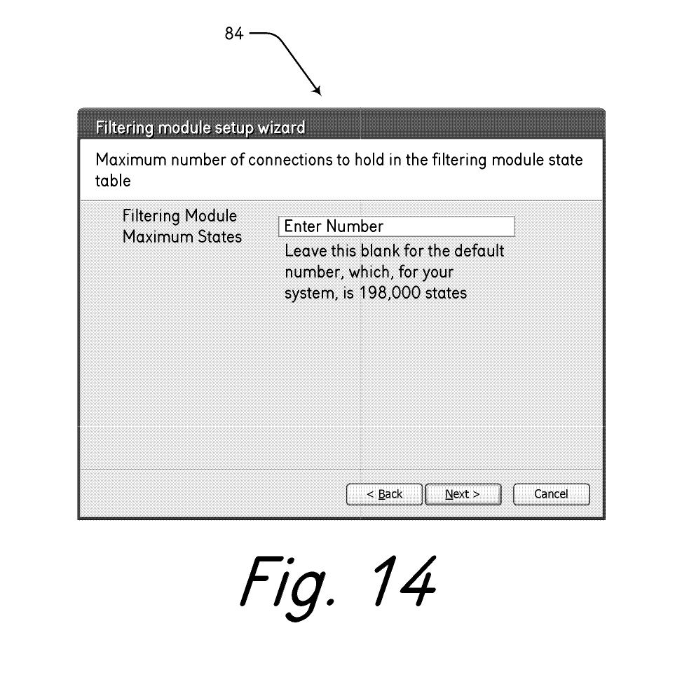

FIG. 15 is a drawing of a filtering module rule specification setup screen for the WAN.

FIG. 16 is a drawing of a filtering module rule specification setup screen for the LAN.

FIG. 17 is a flow chart showing the operation of an example embodiment of an AISA.

FIG. 18 is a flow chart showing more detail concerning the filtering of rules.

FIG. 19 is a software architecture block diagram illustrating the structure of software used in one embodiment of the present invention.

Certain of the Figures are subject to the copyright of Secure Crossing Research and Development, Inc. 2011. However, no objection is made to the reproduction of the Figures in conjunction with this patent application or any patent that may issue therefrom.

### DETAILED DESCRIPTION OF THE EMBODIMENTS OF THE INVENTION

As used herein, the term “rule” or “filtering module rule” refers to the specification of an action taken with network traffic. The term “ruleset” refers to an ordered group of rules such as a whole. Unless otherwise specified, the term “ruleset” refers to the entire group of rules, both user configured and automatically added, to an anti-intrusion and security apparatus.

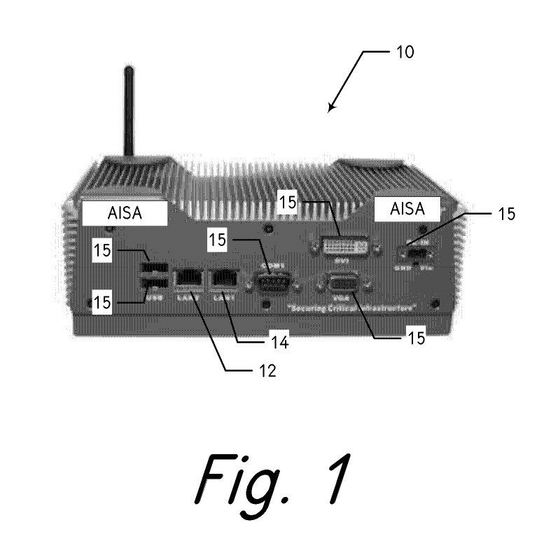

In at least one embodiment of the present invention and referring to FIG. 1, an anti-intrusion and security apparatus (AISA) 10 includes two or more gigabit Ethernet ports, for example, Ethernet ports 12 and 14. Port 12 is configured to communicate through an Internet connection or, more generically, any wide area network (WAN), and port 14 is configured to communicate with an internal local area network (LAN). AISA 10 is not limited to having only a single port 12 configured to communicate via Internet or WAN or a single port 14 configured to communicate via LAN. Some embodiments are provided with a plurality of ports 12 configured to communicate using different IP Internet addresses and/or a plurality of WANs, and/or with a plurality of ports 14 configured to communicate with a plurality of LANs or LAN addresses. Such embodiments are simply scaled-up versions of an AISA 10 having only one Ethernet ports 12 and one Ethernet port 14, so, for one skilled in the art, it is necessary to describe in detail embodiments having only one Ethernet ports 12 and one Ethernet port 14. Additional ports 15 of a variety of types may be provided to connect a terminal or workstation for control of AISA 10, for supplying power, and/or adding addion memory, such as an external hard drive or flash drive.

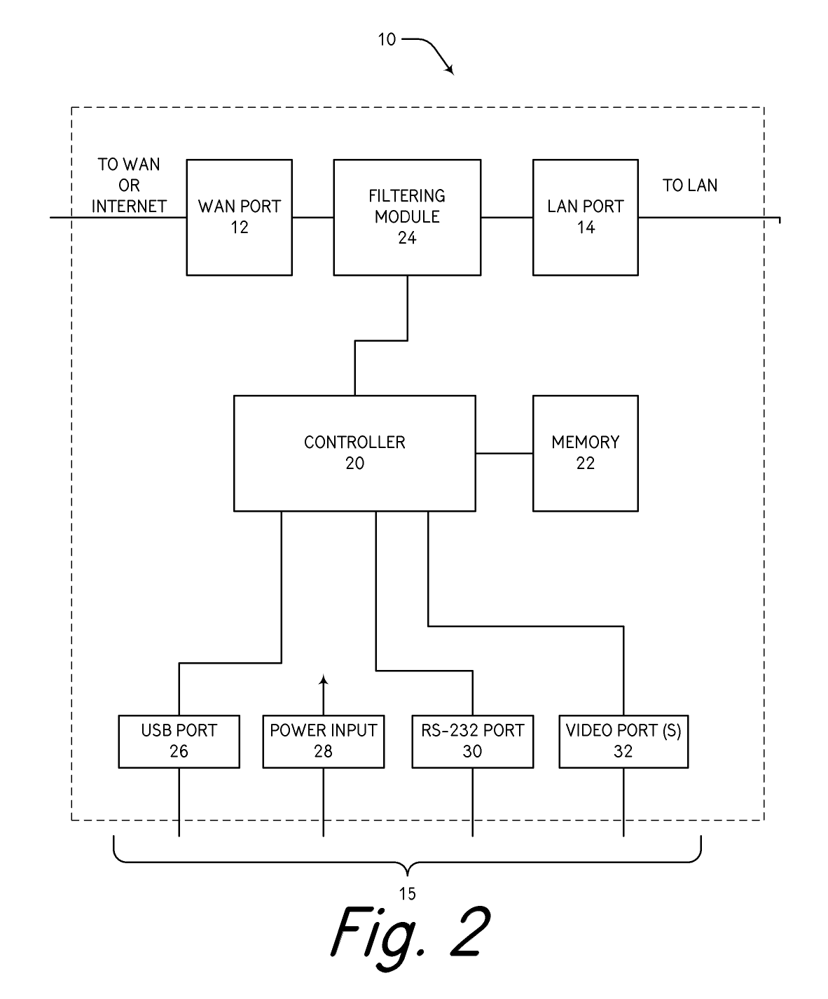

More particularly, and referring to FIG. 2, AISA 10 includes a controller or microprocessor 20 and memory 22. Memory 22 may be, for example, random access memory (RAM), non-volatile random access memory (NVRAM), or some combination thereof, and some or all of memory 22 may be included in controller 20. Controller 20 executes a control program embedded in memory 22 and uses this control program to operate one or more filtering modules 24, which may itself be included in controller 20 and memory 22, and/or which may itself have additional memory (not shown in FIG. 2). Filtering module 24 controls ingress and egress through WAN port 12 and LAN port 14. In the illustrated embodiment, power for AISA 10 is provided through power input 28. Additional memory, such as for filtering module tables or rules, may be provided at USB port 26. Controller 20 and/or filtering module 24 may run programs under the FreeBSD operating system, for example, but this example is not intended to limit the operating system so used in any way. Other embodiments may utilize an embedded form of the Windows operating system, another variant of the UNIX operating system, or the LINUX operating system, for example.

An RS-232 port 30 is provided for a user terminal, workstation, or computer (not shown in FIG. 2), which may also receive video output through video port 32. A mouse (not shown in FIG. 2) may be connected to an additional USB port 26 (not shown in FIG. 2) or to a terminal connected to RS-232 port 30. In some configurations, AISA 10 may accept user input from a terminal somewhere in a connected WAN or LAN.

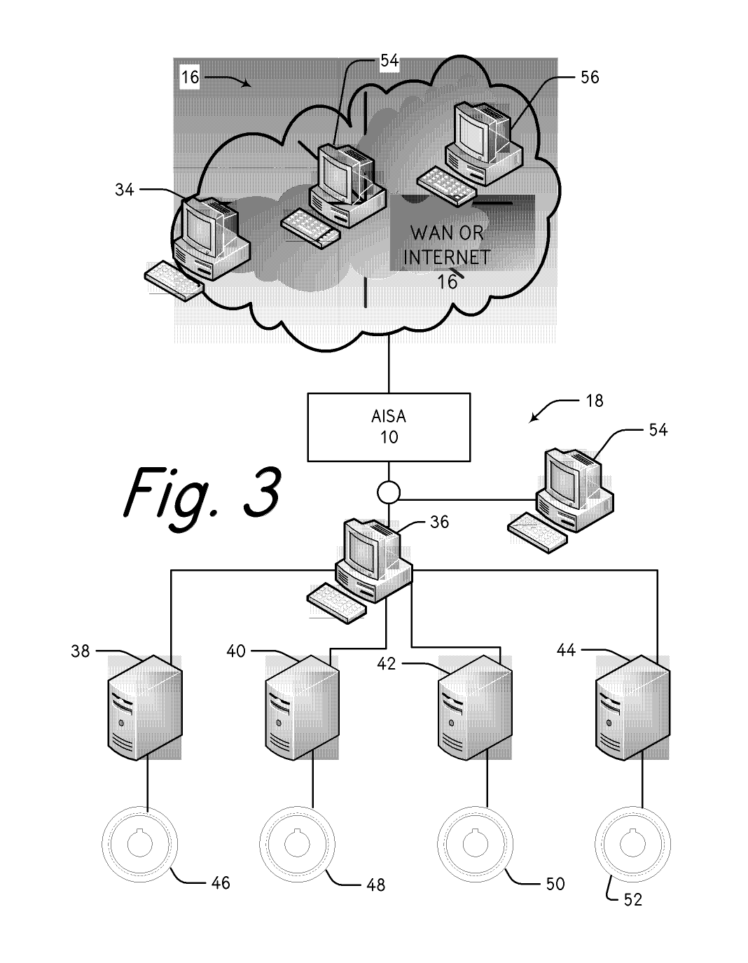

In some embodiments and referring to FIG. 3, AISA 10 is used to protect a private LAN 18 that includes on or more industrial controllers 38, 40, 42, 44 configured to operate associated industrial equipment 46, 48, 50, and 52. obtain its IP address from a server 36 in LAN 18 via DHCP and to provide a configuration interface that can be accessed by a browser running on a computer 54. Let us suppose, for example, that an IP address of 192.168.200.1 is assigned by a computer 36 in LAN 18 to AISA 10. A computer 54 connected within LAN 18 could then browse https://192.168.200.1 to configure AISA 10. After logging in, AISA 10 automatically invokes a setup wizard. In some configurations, AISA 10 may be preconfigured so that it is not necessary to invoke the setup wizard, but in such configurations, a method to manually invoke the setup wizard (such as browsing to System>Setup Wizard) may be provided. AISA 10 may also be provided with a WAN IP address by a server 34 at or controlled by an Internet service provider so that another computer or computers 54, 56 may configure AISA 10.

A setup wizard comprising code in memory 22 and that is executed by controller 20 is provided in at least one embodiment of the present invention. It will be recognized that variations of the setup wizard may be provided in other embodiments, but these variations will be evident to those skilled in the art of coding upon reading the details of the embodiment described below.

General Information Screen

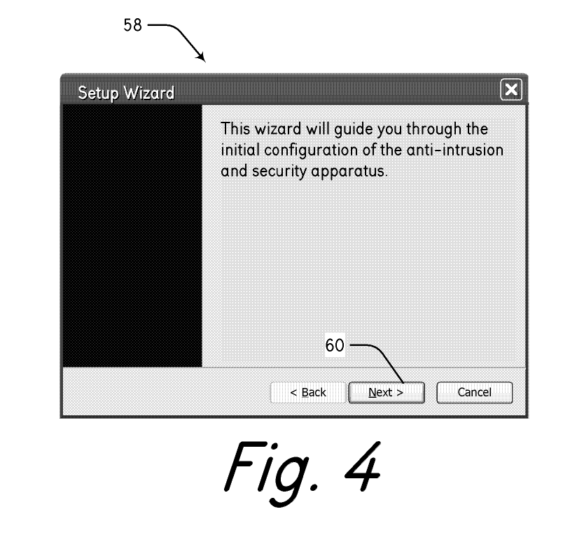

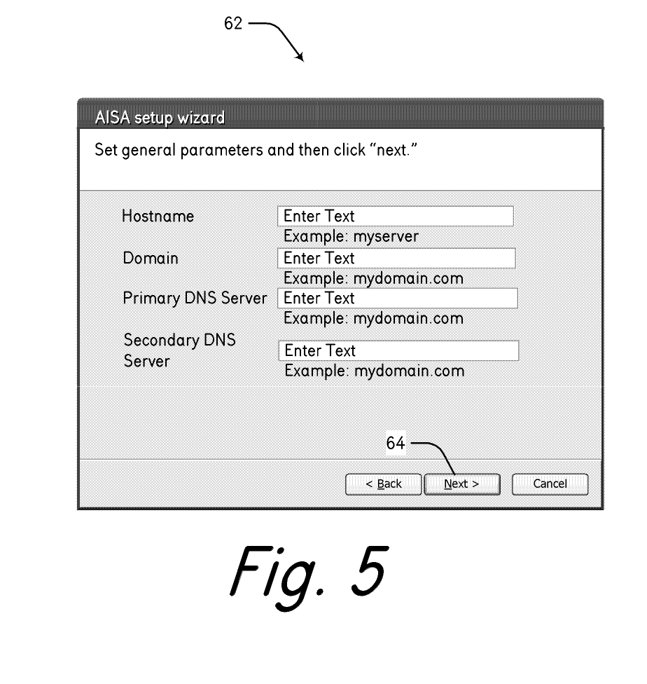

Referring to FIG. 4, an informational pop-up 58 is shown to a user to inform him or her that the initial configuration of AISA 10 is about to begin. After the “Next” button 60 of informational pop-up 58 is clicked by a user and referring to FIG. 5, the setup wizard displays a window 62 that next asks for the name of AISA 10 and the domain in which it resides. The hostname can be, but need not necessarily be restricted by AISA 10 to follow common hostname conventions, such as starting with a letter followed by only letters, numbers, and hyphens. The domain name can be one assigned by a domain naming authority, e.g., example.com or <something>.local, where <something> can be something arbitrarily selected, such as a company name, a last name, a nick name, etc. The hostname and domain name are combined to make up the fully qualified domain name of your router.

The Primary DNS Server and Secondary DNS Server IP addresses may be provided, if known. For dynamic WAN types such as DHCP, PPTP or PPPoE connections, the DNS servers will usually be automatically assigned by an ISP and can be left blank. After the user is finished filling in window 62, the user clicks the Click Next button 64 to proceed.

NTP and Time Zone Configuration

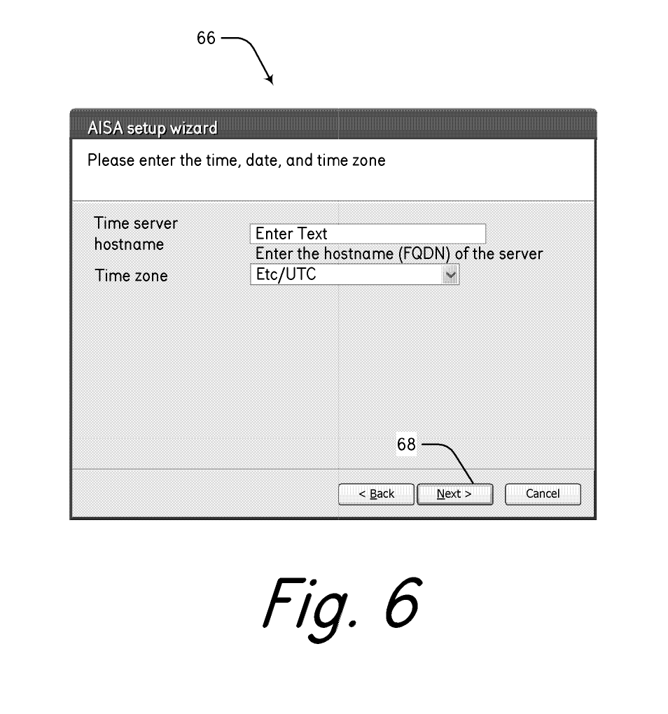

Referring now to FIG. 6, the next window 66 accepts information from the user to select a Network Time Protocol (NTP) server and the time zone in which this server resides. Unless the user has a specific preference for a particular NTP server such as one inside the LAN, the time server hostname in the setup wizard can provide, as a fault selection, pool.ntp.org, which picks random servers from a pool of known-good NTP hosts. The user then chooses, for the Timezone selection, a geographically named zone which best matches the location of AISA 10. When finished, the user clicks the Next button 68 to continue.

WAN Configuration

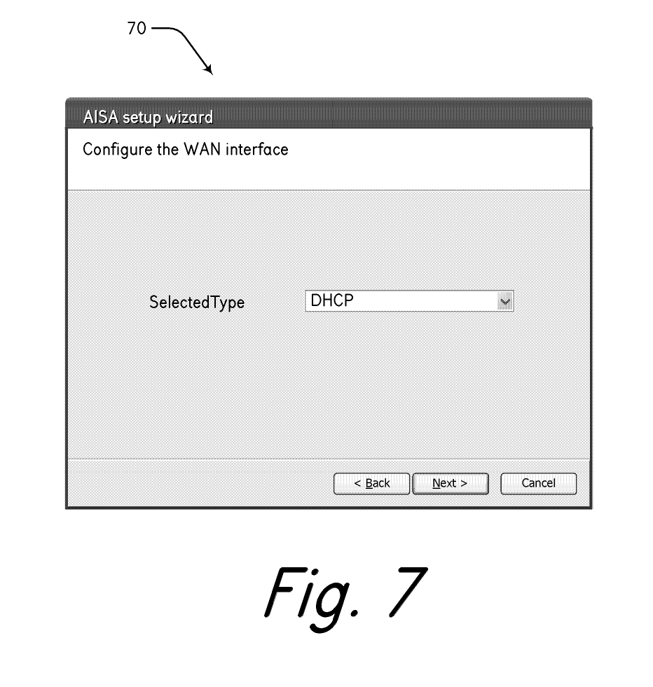

In some embodiments and referring to FIG. 7, a user selecting a WAN type ISP connection type results in the webserver presenting a window 70 requesting further information to match information needed by the ISP to allow communication over WAN 16. Possible choices may include Static, DHCP, PPPoE, and PPTP.

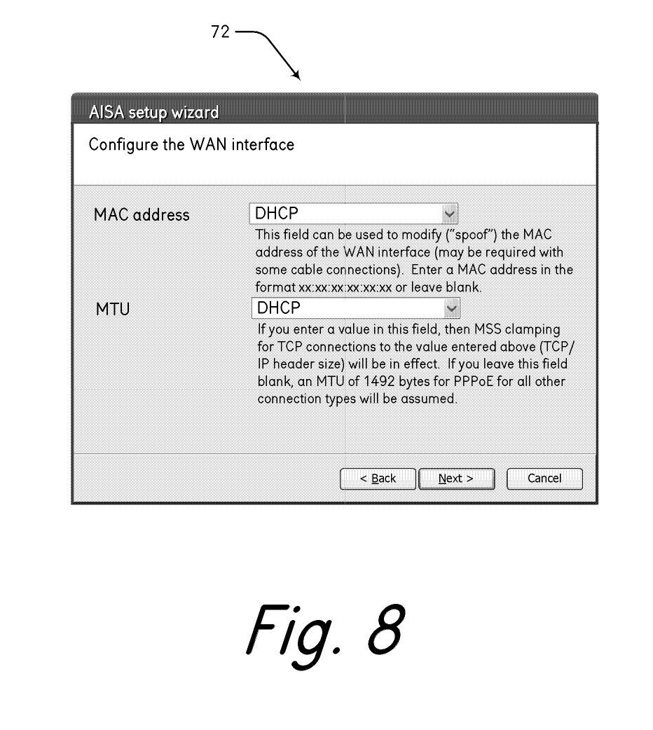

A MAC Address field in window 72 of FIG. 8 is useful for replacing an existing router with minimal complications. Some ISPs, particularly those run by cable providers, will not work properly if a new MAC address is encountered. Some require power cycling the modem, others require registering the new address with them over the phone. If this WAN connection is on a network segment with other systems that locate it via ARP, changing the MAC to match and older piece of equipment rather than having to clear ARP caches or update static ARP entries may simplify the use of AISA 10 in a network.

In some configurations, the Maximum Transmission Unit (MTU) size field can be left blank by the user, but may be changed if, for example, a lower MTU is needed to ensure packets are sized appropriately for a particular ISP. In most configurations, a default value for the WAN connection type is provided that will work properly.

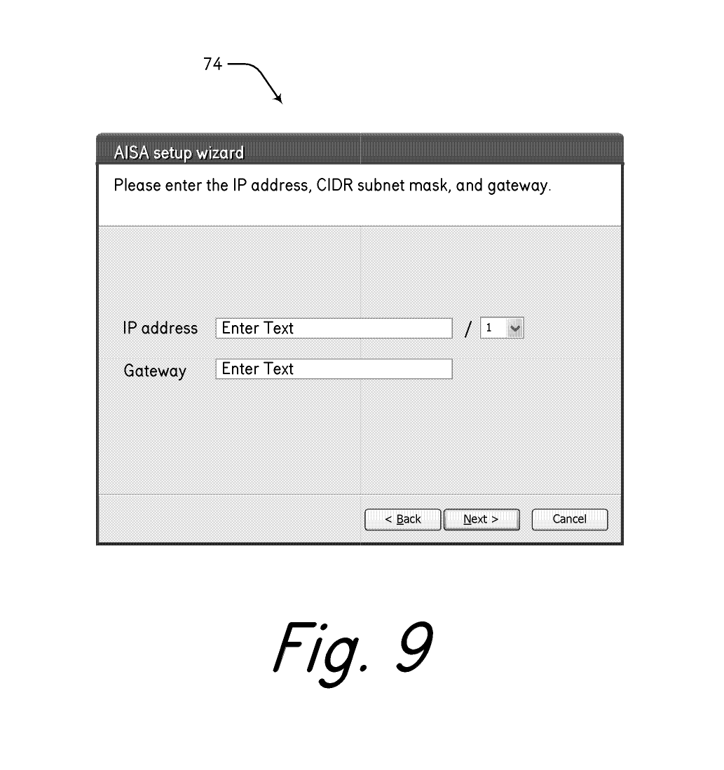

Referring to FIG. 9, if the “Static” choice for the WAN type is chosen, the wizard prompts the user via a window 74 for an IP address, CIDR Subnet mask, and Gateway. This information can be obtained from the ISP or WAN provider. Both the IP Address and Gateway must reside in the same Subnet.

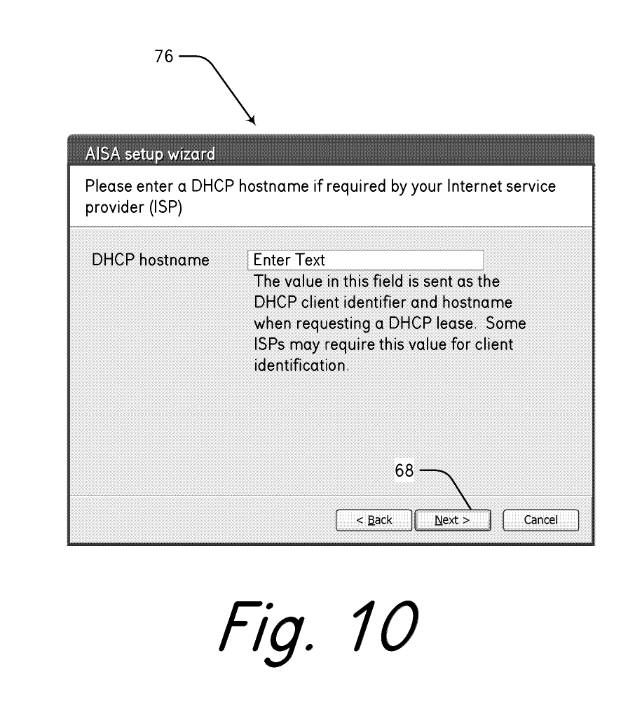

Referring to FIG. 10, some ISPs require a certain DHCP hostname to be sent along with the DHCP request to obtain a WAN IP. Thus, a window 76 is presented by the setup wizard in some embodiments of the present invention to prompt the user to supply the DHCP hostname. This field may be left blank unless it is required by the ISP.

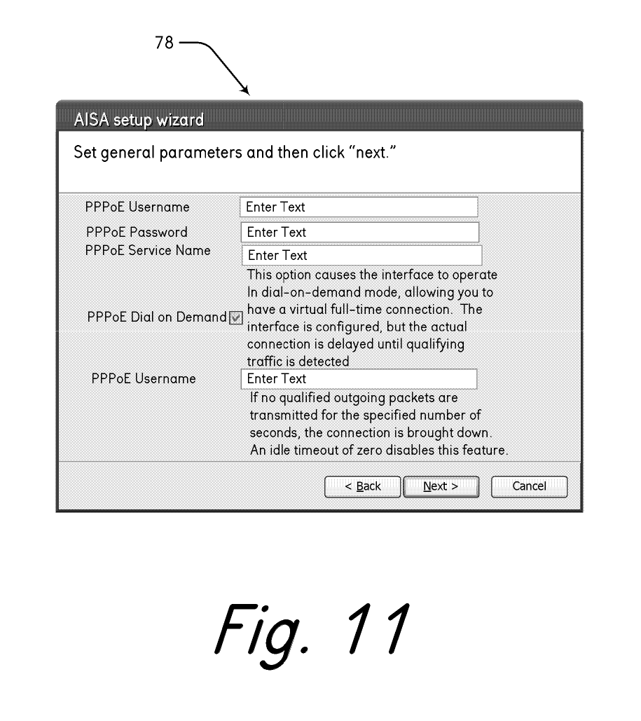

When using the PPPoE (Point-to-Point Protocol over Ethernet) WAN type and referring to FIG. 11, a window 78 is presented by the wizard to prompt the user to supply at least a PPPoE username and PPPoE password. This information can be provided by the ISP typically in the form of an e-mail address, such as mycompany@ispexample.com. The PPPoE Service name may be required by some, but not all ISPs, and thus may be left blank in some configurations.

AISA 10 also provides a PPPoE dial on demand option that leaves a connection to WAN 16 down or offline until data is requested that requires connection to WAN 16. Logging into a PPPoE dial on demand service is quite fast, so the delay while a connection is setup may be negligible. However, if there are any services running on internal network or LAN 18, a user may choose not to select this option.

The PPPoE Idle timeout specifies how much time AISA 10 lets the PPPoE connection go without transmitting data before disconnecting. This option is only useful when coupled with Dial on demand, and is typically left blank (i.e., disabled).

A PPTP (Point-to-Point Tunneling Protocol) WAN type option window (not shown) is provided in some embodiments of the present invention. This option is for ISPs that require a PPTP login rather than connecting to a remote PPTP Virtual Private Network (VPN). These settings can be obtained from the ISP if this type of login is required. A local IP address, CIDR subnet mask, and Remote IP Address are required to establish the connection. The displayed option window is similar to window 78 except that the term “PPPoE” is replaced by “PPTP,” the “PPPoE service name” input field is replaced by a “PPTP Local IP Address field that includes a mask, and a “PPTP Remote IP Address” field is added.

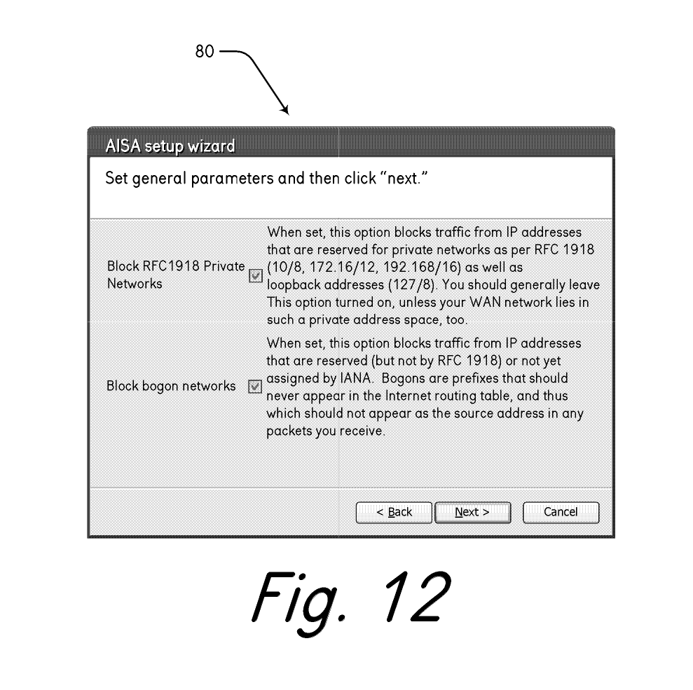

Referring to FIG. 12, the setup wizard provides a window 80 for ingress filtering, i.e., the prevention of invalid traffic from entering internal network 18. Selecting “Block RFC 1918 Private Networks” blocks registered private networks such as 192.168.x.x and 10.x.x.x from making connections to the IP address of WAN port 12. If the WAN IP address of AISA 10 resides on a privately numbered network, “Block RFC 1918 Private Networks” would likely not be selected by a user. The “Block bogon networks” option will stop traffic from coming in that is or appears to be sourced from reserved or unassigned IP space that should not be in use. In some configurations, AISA 10 periodically and automatically updates the list of bogon networks in the background.

LAN Interface Configuration

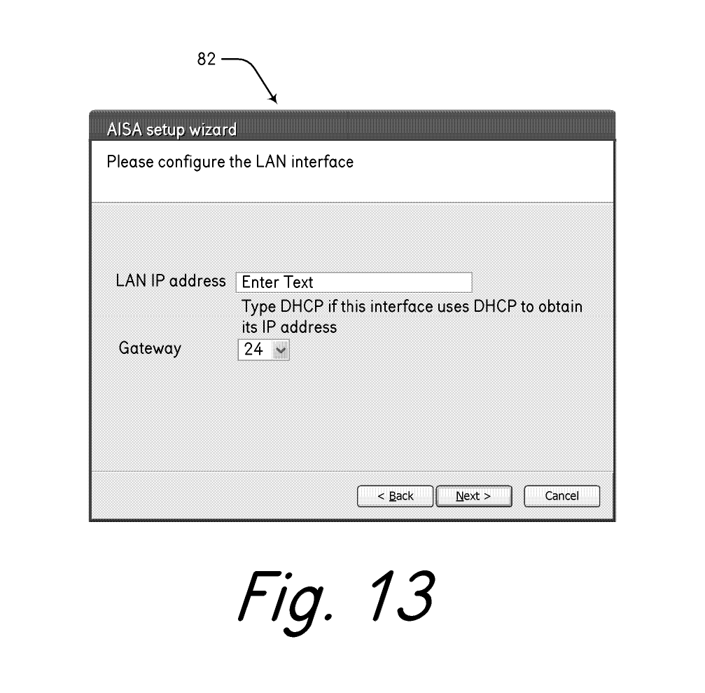

Referring to FIG. 13, the setup wizard provides a window 82 to provide a user with an opportunity to change the LAN IP Address and Subnet Mask. If these settings are changed, the user's PC IP address will have to be adjusted, its DHCP lease released or renewed, or the user will need to perform a “Repair” or “Diagnose” on LAN network port 14 when he or she is finished with the setup wizard.

Set Admin Password

The setup wizard provides a window (not shown in the Figures) that allows a user to change an administrative password that is used to access the setup wizard. After clicking the “Next” button, a concluding window for the setup wizard (also not shown) will be presented by the web server. A “reload” button on this concluding window can be clicked by the user to reload the WebGUI with the new settings.

Configuring the Filtering Module

Rulesets

In AISA 10, rulesets are evaluated on a first match basis, wherein the first rule of the ruleset that matches is interpreted by AISA 10 to determine how to handle a data packet. Processing stops for the data packet, and after reaching this match, the action specified by that rule is taken. The most permissive rules are best placed toward the bottom of the ruleset so that restrictions or exceptions can be made above them.

Stateful Filtering

Referring again to FIG. 2, AISA 10 contains a stateful filtering module 24, permitting traffic on the interface or port 12 or 14 where the traffic is initiated. When a connection is initiated by a device that is directed through AISA 10 that matches a “pass” rule in AISA 10, an entry is created in the state table of AISA 10 in memory 22 in which information on active connections through AISA 10 is retained. Reply traffic to connections initiated inside internal network 18 is automatically allowed back into network 18 by the state table. This reply traffic may include related traffic using a different protocol than that initiated by the device, such as ICMP control messages that may be provided in response to a TCP, UDP, or other connection.

State Table Size

The AISA 10 state table in memory 22 has a maximum size in some configurations of the present invention to avoid memory exhaustion. For example, in some configurations, each state may require approximately 1 KB of RAM. The state table size in many such configurations is dynamically calculated based on the amount of memory installed in the system. In at least one configuration, a default state table size in an AISA 10 with 2 GB RAM is 198,000 states. If 198,000 active connections are traversing an AISA 10 configured in this manner, any additional connections will be dropped. This limit can be increased by browsing to the System>Advanced page, which causes the webserver to provide a GUI interface on which the user can click a Filtering Module/NAT tab. A wizard then provides a window 84 in which the desired number for Filtering Module Maximum States can be entered. A safe maximum limit depends on the other features in use on AISA 10, although many configurations are provided with sufficient memory to accommodate up to 1 million states. To aid in determining how many states may be needed, some AISA 10 configurations provide a display of historical state usage that can be accessed by a user.

Ingress Filtering

Ingress filtering refers to the filtering of traffic coming into internal network 18 from the Internet or other wide area network 16. In deployments having a plurality of WAN or Internet ports 12, there may be a plurality of ingress points if the plurality of ports 12 are actually deployed. A default ingress policy for many configurations of AISA 10 is to block all traffic, as no “allow” rules are provided on WAN port 12 by default. However, replies to traffic initiated from internal network 18 are automatically allowed through by the state table.

Egress Filtering

Egress filtering refers to the filtering of traffic initiated inside your network destined for the Internet or any other interface on the filtering module. In some configurations, AISA 10 is pre-programmed with a default LAN rule allowing everything from LAN 18 out to the Internet 16. However, AISA 10 is provided with a GUI interface that allows a user to employ egress filtering.

Experience has shown that most small companies and home networks do not employ egress filtering. The use of such filtering can increase administrative burden, as each new application or service may require opening additional ports or protocols in a filtering module. In some environments, it is difficult to employ egress filtering because administrators may not know precisely what communication occurs on the internal network 18 and are hesitant to break things. In still other environments, workplace politics has a role in the decision whether or not to employ egress filtering.

Nevertheless, tight egress filtering is important for several reasons. Tight egress filtering can limit the impact of a compromised system. Malware commonly uses ports and protocols that are not required on many networks. Many so-called “bots” rely on Internet Relay Chat (IRC) connections to “phone home” and receive instructions. Some malware uses more common ports such as TCP port 80 (normally HTTP) to evade egress filtering, but many other malware do not. By not permitting traffic over TCP port 6667, the usual IRC port, bots that rely on IRC to function will no longer do so.

Outbound SMTP on TCP port 25 should only be allowed to leave internal network 18 from a mail server, if internal network 18 has such a server. If a mail server is externally hosted, devices on internal network 18 should only be permitted to communicate to that specific externally hosted mail server on WAN TCP port 25. This limitation prevents every other system in internal network 18 from being used as a “spam zombie,” since their SMTP traffic will be dropped. Preventing “spam zombies” has the benefit of limiting spam and also helps avoid internal network 18 from being added to numerous blacklists across the Internet that may prevent the sending of legitimate email to many mail servers.

In some circumstances, egress filtering can prevent systems in the internal network 18 from being compromised. Some exploits and worms require outbound access to succeed. For example, the Code Red worm discovered in 2001 caused affected systems to retrieve an executable file via TFTP (Trivial File Transfer Protocol) and then execute it. Web servers do not generally require the use of the TFTP protocol, so blocking TFTP via egress filtering was found to prevent infection by the Code Red worm even on unpatched servers.

Also, the egress filtering provided in some configurations of AISA 10 can be used to limit unauthorized application usage. Some applications, such as VPN clients, peer-to-peer software, and instant messengers rely upon special ports or protocols to function. While a few peer-to-peer and instant messengers port hop to find egress from an internal network 18, many will be prevented from functioning by a restrictive egress ruleset, which is effective in limiting many types of VPN connectivity.

In some configurations of AISA 10, spoofed traffic is automatically blocked based upon the system routing table.

Certain protocols should never be allowed to leave internal network 18 to prevent information about internal network 18 from leaking to Internet or WAN 16. Specific examples include, but are not limited to, Microsoft RPC (Remote Procedure Call) on TCP port 135, NetBIOS on TCP and UDP ports 137 through 139, and SMB/CIFS (Server Message Block/Common Internet File System) on TCP and UDP port 445. Other protocols for which it may be desirable to limit egress include syslog, SNMP, and SNMP traps. By allowing only that traffic which requires out-of-network traffic (i.e., egress from internal network 18 to Internet or WAN 16), misconfigured network devices may be prevented from sending logging and other potentially sensitive information out onto Internet or WAN 16.

Egress filtering can be implemented by first adding rules to AISA 10 for traffic known to require egress. An example of such traffic is shown below in Table I. All other traffic is dropped by a default rule. Logging can be enabled for “pass” rules, which can then be manually or automatically analyzed them to determine what traffic is leaving internal network 18.

TABLE I
EXAMPLE OF KNOWN REQUIRED TRAFFIC

| Description | Source IP | Destination IP | Destination Port |
|---|---|---|---|
| HTTP and HTTPS | Any | Any | TCP 80 and 443 |
| from all hosts | | | |
| SMTP from mail | Mail Server IP | Any | TCP 25 |
| server | | | |
| Recursive DNS | DNS server IP | Any | TCP and UDP 53 |
| queries from | | | |
| internal DNS | | | |
| servers | | | |

In some configurations of the present invention, traffic can be disallowed by two different AISA 10 rules, namely, “block” and “reject.” The block setting silently drops traffic. This is the behavior of the default deny rule in AISA 10, hence in a default configuration, all traffic initiated from the Internet will be silently dropped. On the other hand, the reject rule sends a response to denied TCP and UDP traffic, thereby letting the host that initiated the traffic know that the connection was refused. Rejected TCP traffic gets a TCP RST (reset) in response, and rejected UDP traffic gets an ICMP unreachable message in response. Though some embodiments of AISA 10 allow “reject” to be selected for any rule, IP protocols other than TCP and UDP cannot be rejected but rather are silently dropped because there is no standard for rejecting other protocols. Blocking traffic can be more secure than rejecting traffic for egress control, because blocking prevents internal network 18 from being seen and discovered by a port scanner. For internal interfaces, reject traffic may be more preferable, because when a host tries to access something it is not permitted to access, the application on the host trying to make the access may hang until the connection times out. By rejecting rather than blocking the traffic, the connection is immediately refused, thereby avoiding these hangs.

Notably, AISA 10 can be configured for a specific set of rules for both ingress and egress traffic. In this regard, AISA 10 can function as a bi-directional filtering module.

Introduction to the Filtering Module Rules Screen

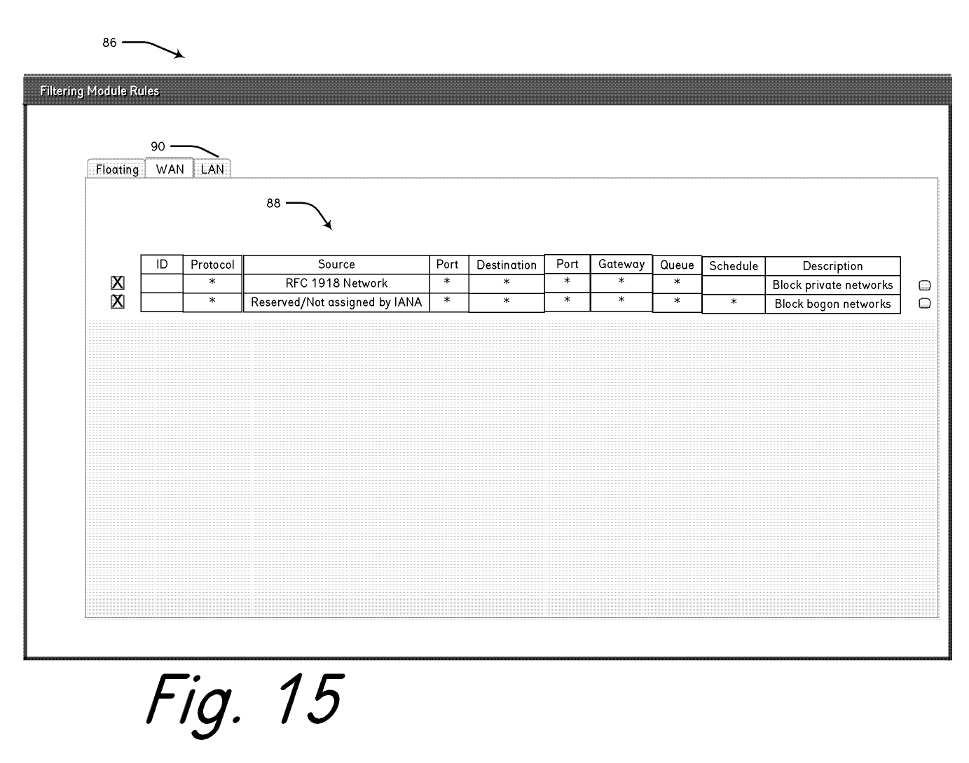

In some embodiments and referring to FIG. 15, when the user browses to Filtering Module>Rules, AISA 10 sets up the web server to display a window 86 with an editable WAN ruleset 88, which by default has no entries other than to block private networks and block bogon networks if these entries have been enabled. If the user clicks to the right of the block private networks or block bogon networks rules in this example, the web server will display a WAN interface configuration page, where these options can be enabled or disabled.

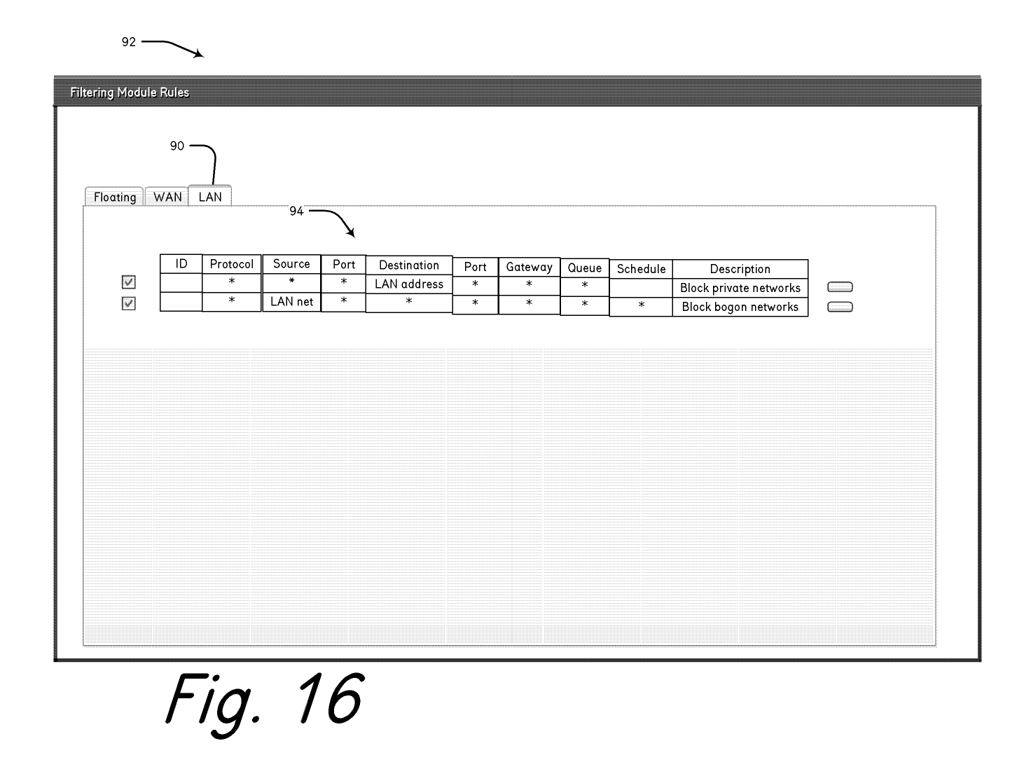

If the user clicks on LAN tab 90, the web server displays an editable screen 92 with LAN rules 94, as seen in FIG. 16. By default, this screen includes only a placeholder for the anti-lockout rule and the Default LAN-> any rule. As with the select block private network and bogon network rules on the WAN tab, when the user clicks next to the anti-lockout rule, the web server navigates to the settings page where the user can disable the anti-lockout rule. The anti-lockout rule allows access on the LAN interface to the AISA 10's LAN IP address on port 22 (SSH), 80 (HTTP) and 443 (HTTPS) to ensure that administrative access to the unit is maintained even if the filtering module rules for the LAN are altered such that access would otherwise be cut off.

The user can review rules for other interfaces by clicking their respective tabs. OPT interfaces will appear with their descriptive names, so if the OPT1 interface is named DMZ, then the tab for its rules will also say DMZ.

To the left of each rule is an indicator icon showing whether the action of the rule is pass, block, or reject. If logging is enabled for the rule, some embodiments of the web server also show a blue circle containing an “i” (not shown in the Figures). If a rule has advanced options set, an “a” will be displayed (also not shown in the Figures.). The same icons are used for disabled rules, except the icon, like the rule, will be grayed out.

Adding a Filtering Module Rule

The web server can accept clicks on either of the buttons on the Filtering Module:Rules screen to add a new rule. Clicking on the top button adds a rule to the top of the ruleset, whereas clicking on the bottom button adds a rule at the bottom.

To make a new rule that is similar to an existing rule, the user can click at the end of the row containing the rule to copy. The web server then displays an edit screen with settings for the existing rule pre-filled and ready to be adjusted.

Editing Filtering Module Rules

The web server allows a user to edit filtering module rules by clicking to the right of a rule or by double clicking anywhere on the line containing the rule. The web server will then present an edit screen for that rule, where the user can make any needed adjustments.

Moving Filtering Module Rules

Rules may be reordered on their own or in groups. To move rules in the list, a user can check a box next to rules that should be moved or the user can single click the rule (which will also check the box), then click the button on the row underneath the relocated rules. When the user hovers the mouse pointer over the display, the web server will present a thick bar to indicate where the rules will be inserted. After the user clicks, the rules will be inserted above the chosen row. A user may also select rules to move by single clicking anywhere inside of the row he or she wishes to select.

Deleting Filtering Module Rules

To delete a single rule, a user can click to the right of the rule. The web server then prompts to confirm the deletion, and the user can then click “OK” to confirm that he or she actually wants to delete the rule.

To delete multiple rules, a user can check a box at the start of rows that should be removed and then click at the bottom of the list. The user may also select rules by single clicking anywhere on a line containing the rule.

Aliases

Aliases allow a user to group ports, hosts, or networks and refer to them by name in filtering module rules, NAT configurations and traffic shaper configurations. Aliases can provide significantly shorter and more manageable rulesets. Boxes in the web interface are presented with a red background to indicate where aliases can be used. (Aliases in this context should not be confused with interface IP aliases, which permit the addition of additional IP addresses to a network interface.)

Configuring Aliases

To add an alias, a user would navigate to the Filtering Module> Aliases screen and click a button. To add new members to an alias, a user would click at the bottom of a list of entries on a Filtering Module:Aliases:Edit screen.

Host aliases allow the creation of groups of IP addresses.

Network aliases allow the creation of groups of networks or IP ranges via the use of CIDR summarization. Single hosts can also be included in network aliases by selecting a /32 network mask.

Port aliases enable the grouping of ports and port ranges. The protocol is not specified in an alias but rather in a filtering module rule in which an alias is used and that filtering module rule defines the protocol as TCP, UDP, or both.

Boxes are presented by the webserver with a red background to indicate that they will accept an alias. When the user types the first letter of an alias into any such input box, a list of matching aliases is displayed. The user can select the desired alias or type its name out completely. Only aliases of the appropriate type are shown. For fields that require an IP address or subnet, only host and network aliases are shown. For fields that require ports, only port aliases are shown. If there are multiple aliases of the appropriate type beginning with the typed letter, the drop down list that appears shows all the matching aliases of that type.

If a user hovers a mouse over an alias on a Filtering Module>Rules screen, a box appears showing the contents of the alias with the descriptions included in the alias.

In some configurations of the present invention, AISA 10 permits the nesting of aliases within other aliases, and includes the ability to enter a URL location of an alias for download.

Filtering Module Rule Best Practices

Default Deny

There are two basic philosophies in computer security related to access control, namely “default allow” and “default deny.” A “default deny” strategy should always be used with AISA 10 filtering module rules. The rules should be configured to permit only the bare minimum required traffic for the needs of the network and drop all other traffic with the default deny rule of AISA 10. The number of deny rules in the ruleset will thus be minimized

In a default two interface LAN and WAN configuration, AISA 10 provides a “default deny” rule on the WAN interface and a “default allow” rule on the LAN interface. All inbound traffic from the Internet is denied and all outbound traffic from the LAN is permitted. All known home grade routers use this methodology as do all known similar routers and commercial offerings. However, this default configuration is not usually the best configuration in an industrial plant.

Some firewall users may ask, “what bad things do I need to block?” That's the wrong question, as it applies to a firewall in which the default rule is to permit traffic. Noted security professional Marcus Ranum includes default permit in his “Six Dumbest Ideas in Computer Security” paper. The paper can be found at http://ranum.com/security/computer_security/editorials/dumb/index.html.

A better strategy is to permit only what is required, avoid leaving the “default allow all” rule activated on the LAN, and adding block rules for undesirable traffic above the permit rule. More particularly, the strategy should be to allow only known “good” packets rather than block “bad” packets, at least to the extent possible.

A shorter ruleset is easier to manage. Long rulesets may be difficult to understand and error prone, overly permissive, and significantly more difficult to audit. Aliases can be used to keep rulesets as short as possible.

Review Your Rules

A user should manually review his or her filtering module rules and NAT configurations on a periodic basis to ensure that the rules and configurations still match the minimum requirements of the current network environment. The recommended frequency of such review varies from one environment to another. In networks that do not change frequently and that have a small number of filtering module administrators and effective change control procedures, quarterly or semi-annual reviews are usually adequate. For fast-changing environments or those with poor change control and a larger number of filtering module administrators, the configuration should be reviewed on at least a monthly basis.

In all but the smallest networks, it can be hard to recall the configuration of the filtering module and the reasons for its being configured in that manner. Therefore, use of the description field in filtering module and NAT rules is always recommended. In larger or more complex deployments, the user should also maintain a more detailed configuration document describing the entire AISA 10 configuration. When reviewing the configuration in the future, this detailed configuration document should help a user to determine which rules are necessary and why they are necessary.

It is important to keep this detailed configuration document up-to-date. When performing periodic configuration reviews, the user should review this document to ensure the document remains up-to-date with the current configuration. The user should ensure that this document is also updated whenever configuration changes are made.

Reducing Log Noise

The “default deny” rule in AISA 10 enables logging by default, so that all traffic blocked from the Internet is logged. In many environments, and by way of example, NetBIOS broadcasts from Windows machines will swamp this log. To avoid the problem, a “block” rule can be added on the WAN interface for repeated noise traffic. By adding a block rule that does not enable logging, repeated noise traffic will still be blocked, but will no longer fill the logs.

A rule can be configured to reduce log noise. For example, a rule can be added to block, but not log, traffic with a destination address of the broadcast address of that subnet of the LAN.

Similar rules should also be added that match the specifics of any log noise seen in any particular environment. The user should check the filtering module logs under Status>System Logs, Filtering Module tab to see what kind of traffic is being blocked and to review its frequency. As a rule of thumb, if any particular traffic is consistently being logged more than 5 times a minute, logging of this traffic should probably be presented.

Logging Practices

In some embodiments of the present intention, AISA 10 does not log any passed traffic and logs all dropped traffic. However, blocked traffic cannot harm an industrial plant, so its log value is limited, whereas traffic that gets passed could be very important log information to have if a system is compromised. After eliminating any useless noise as described above, the remaining log entries are of some value for trend analysis. If there is significantly more or less log volume than usual, a user should investigate why that is. OSSEC, an open source host-based intrusion detection system (HIDS), is an example of one system that can gather logs from AISA 10 via syslog and alert a user to log volume abnormalities.

Rule Methodology

Rules in AISA 10 are applied on a per-interface basis, and always in the inbound direction on that interface. Thus, traffic initiated from the LAN is filtered using LAN interface rules. Traffic initiated from the Internet is filtered with WAN interface rules. Because all rules in AISA 10 are stateful by default, a state table entry is created when traffic matches an allow rule. All reply traffic is automatically permitted by this state table entry.

The web server in AISA 10 provides a “Floating Rules” tab for the creation of outbound rules. Outbound rules are almost never required, because filtering is applied on the inbound direction of every interface. However, in some limited circumstances such as a filtering module with numerous internal interfaces, having outbound rules available can significantly reduce the number of required filtering module rules. In such a case, egress rules for Internet traffic can also be applied as outbound rules on the WAN to avoid having to duplicate these rules for every internal interface.

Automatically Added Filtering Module Rules

Anti-Lockout Rule

To prevent locking a user out of the web interface, AISA 10 enables an anti-lockout rule by default. The anti-lock out rule is configurable on the System>Advanced page under Disable webConfigurator anti-lockout rule. This automatically added rule allows traffic from any source inside the industrial plant to the management daemons (SSH, HTTP, HTTPS) listening on the LAN IP of AISA 10.

In security-conscious environments, this automatically added rule should be disabled and the LAN rules should be configured so that only an alias of trusted hosts can access the administrative interfaces of the filtering module.

Restricting Access to the Administrative Interface from LAN

To restrict access to the administrative interface from the LAN, the filtering module rules should be configured to restrict access to the management interfaces. For example, in an industrial plant that uses both SSH and HTTPS for management, a ManagementPorts alias containing these ports can be created by the user. Then, an alias is created by the user for hosts and/or networks that will have access to the management interfaces. The user can then configure LAN filtering module rules to allow access to the hosts and deny access to all else.

In one example, DNS queries to the LAN IP are allowed, but all other traffic is rejected. Or, for example, access from the management hosts to the management ports is allowed, and all other traffic to the management ports is rejected.

After the filtering module rules are configured, the user checks the Disable webConfigurator anti-lockout rule on the System>Advanced page and clicks “Save.”

If the user can no longer access the management interface after disabling the anti-lockout rule, the anti-lockout rule can be re-enabled by setting the Set LAN IP option at the console menu to its current IP.

Anti-Spoofing Rules

AISA 10 uses an antispoof feature to block spoofed traffic and to provide Unicast Reverse Path Forwarding (uRPF) functionality as defined in RFC 3704. The filtering module checks each packet against its routing table, and if a connection attempt comes from a source IP on an interface where the rules indicate that source does not reside, it is dropped. For example, traffic coming into the WAN port with a source IP of an internal network is dropped. Anything initiated on the internal network with a source IP that does not reside on the internal network is dropped.

Block Private Networks

The “Block Private Networks” option on the WAN interface automatically enters a block rule for RFC 1918 subnets. Unless there is a private IP space on the WAN, this option should be enabled to block traffic initiated on the WAN side. Hosts on private networks accessed from the LAN can still be accessed. A user can manually add a rule to block private networks on his or her OPT WAN interfaces by creating an alias containing the RFC 1918 subnets and adding a filtering module rule to the top of the OPT WAN interface rules to block traffic with a source matching that alias.

Block Bogon Networks

Bogon networks are networks that should never be seen on the Internet, including networks with reserved and unassigned IP address space. The appearance of such networks indicates either spoofed traffic or an unused subnet that has been hijacked for malicious use. AISA 10 provides a bogons list that is updated as needed. If a user has enabled the Block bogon networks option, the filtering module will fetch an updated bogons list on the first day of each month from a secure provider of such lists. This list does not change very frequently, and new IP assignments are removed from the bogons list months before they are actually used, so the monthly update is adequate. To confirm that the filtering module can resolve DNS host names and thus allow this update to occur, the user can browse to Diagnostics>Ping and try to ping the secure provider.

IPsec

When a user enables a site-to-site IPsec connection, rules are automatically added to allow the remote tunnel endpoint IP address access to UDP port 500 and the ESP protocol on the WAN IP address used for the connection. When a mobile client's IPsec is enabled, UDP port 500 and ESP traffic is allowed from any source.

As a consequence of policy routing, any traffic that matches a rule specifying a gateway is forced out to the Internet, bypassing IPsec processing. When there is an allow rule specifying a gateway on an inside interface containing a subnet used by an IPsec connection and the destination of the rule is “any,” the filtering module automatically adds a rule to negate policy routing for traffic destined to the remote VPN subnet.

PPTP

When a user enables a PPTP server, hidden rules are automatically added allowing TCP port 1723 and the GRE (Generic Routing Encapsulation) protocol to the WAN IP address from any source IP address.

Default Deny Rule

Connections that do not match any user-defined rules nor any of the other automatically added rules are silently blocked by the default deny rule.

Other details for configuring filtering module rules

Disabled

To disable a rule without removing it from the rule list, a user can check this box. The rule will show in the filtering module rules screen, but the rule will be grayed out to indicate its disabled state.

Interface

The Interface drop down list specifies an interface on which a rule will be applied. Traffic is filtered only at the interface on which the traffic is initiated. Traffic initiated from the LAN destined to the Internet or any other interface on the filtering module is filtered by the LAN ruleset.

Protocol

A user can specify a protocol that a rule will match. The TCP/UDP option matches both TCP and UDP traffic. The ICMP option causes another drop down box to appear where a user can select the ICMP type. Several other common protocols are also available in some embodiments.

Source

A user can enter a source IP address, subnet, or alias in a source field that matches a corresponding rule. The user may also check the “not” box to negate the match.

In the type field a user may specify “Any,” which will match any address; “Single host or alias,” which will match a single IP address/hostname or alias name; or “Network,” which uses both an IP address and subnet mask to match a range of addresses. In some embodiments, several available presets are provided by AISA 10, namely, WAN address, WAN subnet, LAN address, LAN subnet, PPTP clients, L2TP clients, and PPPoE users.

For rules using TCP and/or UDP, the user may also specify a source port here by clicking the “Advanced” button. The source port is hidden behind the Advanced button in some embodiments because the user will normally want to leave the source port set to “any,” as TCP and UDP connections are sourced from a random port in the ephemeral port range (between 1024 through 65535, the exact range used varying depending upon the OS and OS version that is initiating the connection). The source port is almost never the same as the destination port, and should never be configured as such unless the user knows the application he or she is using employs this atypical behavior. It is also safe to define the source port as a range from 1024 to 65535.

Destination

This field is where the user specifies a destination IP address, subnet, or alias that will match a rule. As with the source address setting, the user may select not to negate the match. In some embodiments, for rules specifying TCP and/or UDP, the destination port, port range, or alias is also specified here.

Log

Whether or not this box is checked determines whether or not packets that match this rule are logged to the filtering module log.

Gateway

The gateway field allows a user to specify a WAN interface or load balancer pool for traffic matching this rule.

Description

A user may optionally enter a description in this field for future reference.

Viewing the Filtering Module Logs

For each rule that is set to make a log entry, and for the default deny rule, a log entry is made. In some embodiments, a user may select one of several ways to view these log entries, with varying levels of detail.

Filtering module logs keep only a certain number of records. If the needs of an organization require that the organization maintain a permanent record of filtering module logs for a longer period of time, the logs can be copied to a syslog server as the records are generated.

Viewing in the WebGUI

In some embodiments, filtering module logs are visible from the WebGUI and may be found on the filtering module tab under Status>System Logs. A user can view either parsed logs, which are easier to read, or raw logs, which have more detail. There is also a setting which will show log entries in forward or reverse order.

In some embodiments, parsed WebGUI logs are shown by the webserver in 6 columns, namely, Action, Time, Interface, Source, Destination, and Protocol columns The “Action” column shows what happened to the packet which generated the log entry, namely, whether the packet was processed by a pass, block, or reject rule. The “Time” column displays the time that the packet arrived. The “Interface” column shows through which port the packet entered AISA 10. The “Source” column shows the source IP address and port. The “Destination” column shows the destination IP address and port. The “Protocol” column shows the protocol of the packet, for example, ICMP, TCP, UDP, etc.

The icon in the action column is a link which, when clicked, displays the rule that caused the log entry. This information can be used to troubleshoot rule entries. If the protocol is TCP, extra fields will be shown by the webserver that represent TCP flags present in the packet. These fields indicate various connection states or packet attributes. For example, “S” or “SYN” indicates synchronized sequence numbers. With this attribute, a new connection attempt is logged only when SYN is set. “A” or “ACK” indicates Acknowledgment of data. These acknowledgments are replies to let a sender know data was received OK. “F” or “FIN” indicates that there is no more data from a sender and that the connection was closed. “R” or “RST” indicates a connection reset. This flag is set when replying to a request to open a connection on a port that has no listening daemon. This flag can also be set by filtering module software to turn away undesirable connections.

Viewing from the Console Menu

Raw logs may be viewed directly in real time from a logging interface. For example,

“000000 rule 54/0 (match): block in on vr1: 0.0.0.0.68>255.255.255.255.67: BOOTP/DHCP, Request [|bootp]”

shows that rule 54 (neither shown in the Figs. nor represented by numeral 54 in the Figs.) was matched, which resulted in a block action on the vr1 interface. The source and destination IP addresses are shown next. Packets from other protocols may show significantly more data.

Log entries for legitimate connections may sometimes be blocked and, in some embodiments of the present invention, logged. For example, a TCP FIN packet, which would normally close a connection, may arrive after the state of the connection has been removed because a packet was lost, and the retransmitted packet is blocked because the filtering module has already closed the connection.

Troubleshooting Filtering Module Rules

If filtering module rules are not behaving as desired or as expected, a user should check the filtering module logs (Status>System Logs, on the Filtering Module tab). By default, some embodiments of AISA 10 log all dropped traffic and do not log any passed traffic. Unless “block” or “reject” rules that do not use logging are added, all blocked traffic will always be logged. In some configurations of the present invention, a red X is placed next to logged traffic in the filtering module logs to indicate dropped traffic.

The user can edit rules and review parameters that have been entered for each field. The user can also review rule ordering, mindful that no rules past the first matching rule are evaluated.

Rules must be on the correct interface to function as intended, because traffic is filtered only by the ruleset configured on the interface from which the traffic is initiated. Traffic coming from a system on a LAN destined for a system on any other interface is filtered by only the LAN rules. The same is true for all other interfaces.

Enable Rule Logging

It can be helpful to determine which rule is matching selected traffic. By enabling logging on pass rules, a user can view filtering module logs and click on an individual entry to determine which rule passed the traffic.

Packet captures can aid in troubleshooting and debugging traffic issues. For example, the user can determine from packet captures whether traffic is reaching the outside interface all or leaving the inside interface.

AISA 10 Industrial Filtering Capabilities

Rules and Profiles

Industrial protocol rules and profiles are defined under the Filtering Module>Industrial Protocols menu presented by the webserver. Rules match specific functions or actions within each industrial protocol. Profiles are groupings of rules, their actions (pass, block or log), and the default policy of block or pass for packets not matching any configured rules in the profile.

The three actions available for each rule are pass, log, and block. Log will pass the traffic and also create a log entry showing the traffic was passed.

Using Analysis to Configure Rules

Industrial filter rules can be configured using analysis functionality built into some embodiments of AISA 10. This analysis functionality allows a user to upload a packet capture of traffic for analysis and for adding rules specific to the traffic within the captured packet. If the packet captured contains only traffic that must be allowed, rules are added to pass that specific traffic and to block everything else. The analysis feature can be found under Filtering Module>Industrial Protocols, on the Analysis tab.

Capturing Traffic for Analysis

Configurations of the present invention provide one or more options for capturing the traffic to be analyzed. For example, in one embodiment, AISA 10 offers built-in packet capture functionality under Diagnostics>Packet Capture. Traffic can also be captured from the host initiating the traffic for analysis using Wireshark or any other suitable packet capture tool.

Capturing Traffic from AISA 10

To capture traffic on AISA 10, a user first browses to Diagnostics>Packet Capture. The Interface selection chooses an interface that will be used to capture traffic and can be either the source or destination interface of the traffic.

The Host Address box allows a user to filter the capture to a specific IP address. For example, a user can specify the IP address of a specific PC or PLC to capture only traffic sourced from or destined to that IP address.

The Port box allows filtering to capture only a specified port, capturing both TCP and UDP traffic on that port. This filtering also excludes all protocols other than TCP and UDP.

The Packet Length field specifies the number of bytes of each packet that will be captured. In some embodiments, setting the packet link to “0” captures the entire frame for industrial protocol analysis.

The Count field specifies a number of packets after which the capture will automatically stop. For industrial protocol analysis, and in some configurations of the present invention, setting the count field to “0” will prevent the capture from stopping until the user clicks on the “Stop” button.

The Level of Detail and Reverse DNS Lookup fields are not applicable here and can be left unchanged.

The user clicks “Start” to begin the capture. The traffic to be analyzed is sent through and then the user clicks “Stop.” The web server then presents the user with a “Download Capture” button. The user can click this button to download the resulting pcap file.

The user can then browse to Filtering Module>Industrial Protocols, click the “Analysis” tab and the Browse button, choose the downloaded pcap file, and click “Upload File.” AISA 10 then analyzes the pcap file to show a list of the types of commands sent across the session. The displayed analysis shows how many packets in the capture matched a user-selected, specific command.

Creating Rules

When a user clicks the “+” to the right of any individual line in the Analysis Results, AISA 10 adds a rule matching that specific type of traffic. The check boxes down the left side allow the user to select a plurality of entries to add a plurality of rules at once. After checking the desired items, the user can click the “+” at the very bottom of the screen to add the rules.

Rules can be configured based not only on packet analysis, but upon any other suitable properties as well, including source, destination, or the like. Thus, ingress traffic which passes the packet analysis requirements can be blocked nonetheless if it arrives from an unauthorized source, or if it is directed to an unauthorized destination.

Creating a Profile

A user can edit the profiles options and profile rules by clicking the profiles tab under Filtering Module>Industrial Protocols.

The Profile Name is the name used to refer to the profile when a user configures filtering module rules to assign traffic to this profile.

The Default action defines what the system will do with traffic that does not match any of the specified profile rules.

The Description field can be used to enter a comment helpful to the user.

The user can assign rules to the profile by clicking the “+” under “Profile rules.”

Applying the Profile to Network Traffic

Now that a profile is defined, the user can specify what network traffic will be analyzed by the profile via filtering module rules under the Filtering Module>Rules screen presented by the web server. Traffic is filtered on the interface where it originates. Industrial protocol filtering rules behave in the same as manner as other filtering module rules in every aspect, with the exception that traffic matching a rule specifying an industrial protocol profile will pass only traffic matching the protocol configured in that profile. Hence, care must be taken to ensure the industrial protocol rules are not overly broad in applications in which many types of traffic are passed through the AISA 10.

In an example configuration, a plant floor network is connected to the LAN side of AISA 10, and the corporate network is connected to the WAN. The LAN side subnet is routed to the WAN IP of AISA 10 on the corporate network. All traffic from the corporate network to the plant network is routed through AISA 10. In this example, only the CIP traffic configured in a profile called “My-CIP” is permitted to get from the corporate network to the plant floor. Because the traffic is initiated on the WAN side of the AISA 10, a WAN filtering module rule with this profile is created. The user creates a “CIPhosts” alias containing a list of IP addresses that are authorized to use CIP, as there is no need to permit every host to access CIP. The filtering module rule thus created is:

Action: Pass Interface: WAN Protocol: TCP Source: CIPhosts alias Destination: any Destination port: 44818 Description: enter as desired Advanced option Industrial Protocol: My-CIP

Allowing CIP only from the CIPhosts alias ensures traffic from unauthorized IP addresses that should not be trying to access the plant floor will be blocked. Thus, the Industrial Protocol profile ensures that only authorized actions are taken by authorized hosts.

A rule that specifies “pass” matches the defined industrial protocol filter. The actions of the industrial protocol profile are taken on traffic matching the rule. For example, the “My-CIP” profile permits only valid CIP traffic, specifically only actions defined in the rules within that profile. AISA 10 applies protocol enforcement regardless of the rules configured. For example, when defining a CIP profile in a rule, traffic matching that rule must be CIP rather than HTTP, SSH, or any other protocol.

In one example, a WAN ruleset is provided by a user. A first user-defined rule permits CIP from source IP addresses in a CIPhosts alias, as long as it matches the My-CIP profile. A second rule permits management access to AISA 10 from specifically authorized IP addresses, as defined in a ManagementHosts alias, so authorized staff can manage AISA 10 from the corporate network. The third rule allows pings to the WAN IP address for connectivity testing purposes.

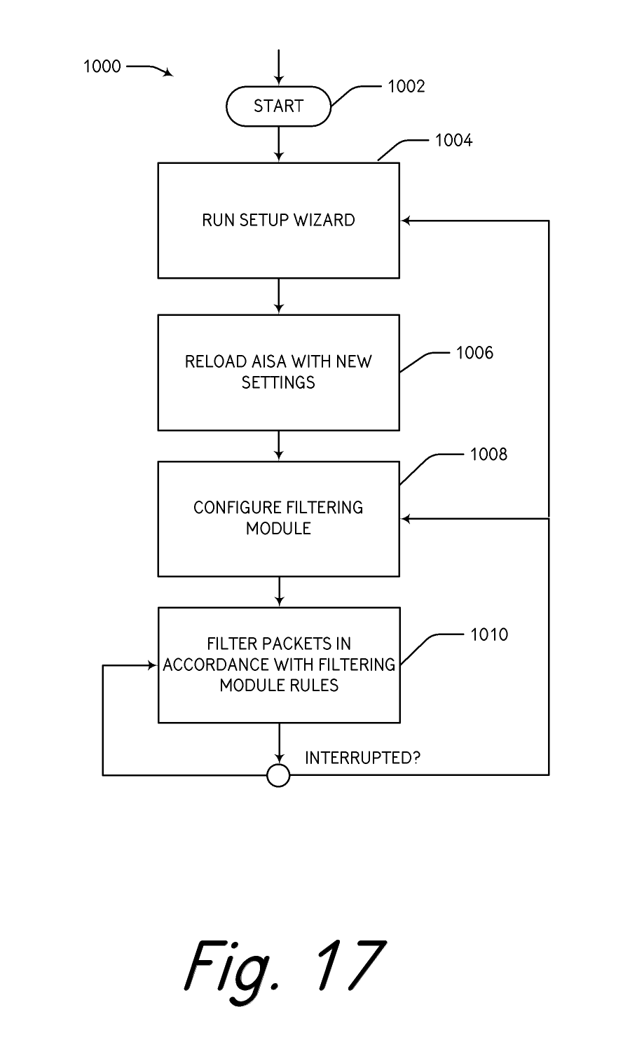

To summarize, some embodiments of the present invention include an AISA 10 that comprises one or more controllers 20, a memory 22, a WAN port 12, and a LAN port 14. Modules comprising at least controller 20 and parts of memory 22 (and optionally, additional memory connect to additional ports, such as USB port 26) include, referring to flow chart 1000 of FIG. 17, at least a setup wizard 1004 and a filtering module configuration module 1008. When first turned on at 1002, AISA 10 runs the setup wizard at 1004 and reloads AISA 10 with new settings at 1006. AISA 10 then requests information to configure filtering module 24 at 1008 from a user using a webserver that provides a GUI interface. After the filtering module is configured at 1008, it can then repeatedly filter packets in accordance with filtering module rules at 1010 until it is interrupted to run the setup wizard again and/or reconfigure filtering module 24. In some embodiments of the present invention, configuring the filtering module further comprises configuring an industrial protocol ruleset (wherein the industrial protocol is a protocol that communicates with an industrial controller operating a machine), and filtering the packets in accordance with filtering module rules further comprises filtering the packets in accordance with rules defined by the industrial protocol ruleset. Filtering the packets in accordance with the rules defined by the industrial protocol ruleset may itself comprise a further parsing of the communication packet to recognize and determine at least a part of the content of objects embedded in industrial protocol packets, as it may be necessary to know the content of such objects to determine whether to pass or drop the communication packet. For example, this parsing of industrial protocol packets may be accomplished by the addition of extra code (“.c” files) and definitions (“.h” files) to the FreeBSD source code and recompiling and linking that code.

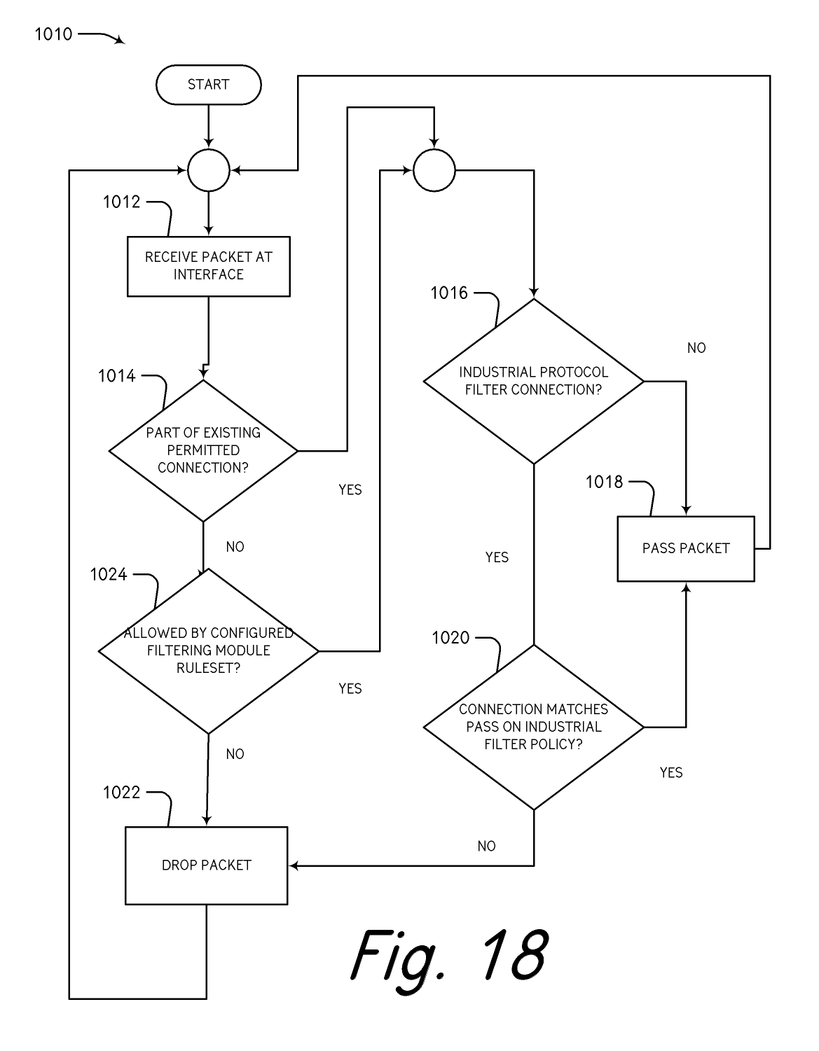

Thus, in some configurations of the present invention and referring to FIG. 18, filtering packets in accordance with filtering module rules 1010 may further comprise receiving a packet at an interface at 1012 and determining whether the packet is part of an existing permitted connection at 1014. If the packet is part of an existing permitted connection, it is next determined at 1016 whether it is part of an industrial protocol filter connection. If not, the packet is passed at 1018 and the next packet is checked at 1012. If the packet is an industrial protocol filter connection at 1016, the packet is checked to determine whether the connection matches a “pass” rule in the industrial filter policy at 1020. If so, the packet is passed at 1018 and the next packet is checked at 1012. If not, the packet is dropped at 1022 and the next packet is checked at 1012.

If the packet received at 1012 is determined not to be part of an existing permitted connection at 1024, the packet is then checked at 1026 to determine whether or not the packet is allowed by user-configured filtering module rules. If not, the packet is dropped at 1022 and the next packet is checked at 1012. Otherwise, the packet is checked at 1016 to determine whether the packet is an industrial protocol filter connection.

Embodiments of the present invention may utilize a software operating system known as FreeBSD, however, configurations are not limited to any particular operating system. Configurations of the present invention may be realized in embedded systems utilizing for example, a 1.6 GB Intel® Atom™ processor and 2 GB of RAM with a 32 GB solid state hard drive. Such embodiments are thus entirely free of electromagnetic components and moving parts. These embodiments may be located as desired with SCADA remote connectivity, including down on a plant floor in its own level environment.

Some embodiments of the present invention utilize a feature of the BSD operating system known as “divert sockets.” The BSD operating system is very good at parsing packets and assembling packets. In one embodiment of the present invention, definitions are added to the FreeBSD kernel so that the kernel can understand and parse six different industrial protocols. The exact number of industrial protocols that can be understood and parsed is not limited to any specific number, such as six. However, appropriate definitions can be added to understand an arbitrary number of industrial protocols.

As data arrives, the BSD kernel parses the industrial protocols and assembles the data into a payload. An engine receives the payload, and one or more analyzers within the engine read the actual contents of the payload. In this manner, the command sequences are determined. The open source program “WIRESHARK” is used in some embodiments to capture packets. Thus, the arriving data stream can be collected in a PCAP at various PLCs and dropped into a packet analyzer engine, or the packet analyzer engine can be operated in a bridge mode to capture packets during a cycle time. For example, PLC “reads” and “writes” may occur at a frequency of 10 per second, while a process that collects the history of the industrial automation system may request information only once every 12 hours. The cycle time is as long as the longest intervals between requests, in this case, 12 hours. By operating during an entire cycle time, every instance of industrial protocol type is captured, along with each source and destination. The packet analyzer engine can thus verify packets are being transferred from the correct sources to the correct destinations.

In one embodiment of the present invention, the packet analyzer engine generates a ruleset to verify the correct transfer of packets. This ruleset is made part of a group policy that is incorporated into a filtering module, wherein previously existing rules may be completely turned off or deleted. Thus, nothing can enter the industrial automation system unless it exactly matches a rule in the group policy ruleset. The group policy serves as a whitelist for packets, which is considerably more effective than a blacklist in that only known good packets are allowed. Packets not on the whitelist are discarded if they are from an incorrect source, even if they contain known good commands. Likewise, packets not on the whitelist will be discarded even if they are from a correct source, yet they contain incorrect commands. The rejected packets are logged in some configurations of the present invention. Thus, even if Stuxnet were brought into a plant, the worm would never get to the industrial controllers and thus never bring down the plant.

In some embodiments of the present invention, code that implements intrusion prevention is embedded in a memory 22 of AISA 10. However, the code may be provided on a tangible object that can be transferred to AISA 10 and/or that can operate, for example, a general purpose computer or workstation, or a differently configured workstation. For example, the code may be provided in computer-readable form on non-volatile memory. Such memory can include, for example, a thumb drive, a ROM, or a magnetic or optical disk.

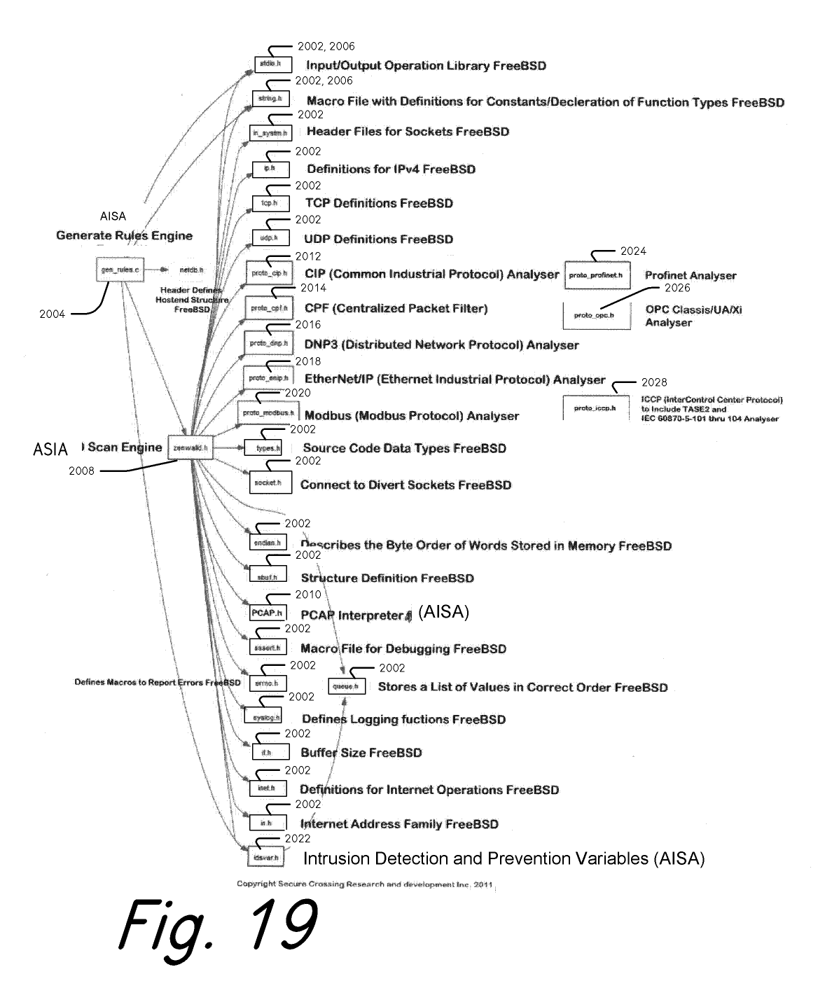

In some embodiments and referring to FIG. 19, AISA 10 software may be implemented using the FreeBSD operating system. Some of the code header files (“.h” files) 2002 that are already supplied as part of the FreeBSD operating system are also shown in FIG. 19. An AISA rule generating engine 2004 (in this example, gen_rules.c) interfaces directly with a few FreeBSD operating system header files 2006 and with an AISA scan engine 2008 (in this example, “zenwalld.h). AISA scan engine 2008 interfaces directly with each of the header files 2002 shown in FIG. 19, including PCAP.h 2010, an interpreter module provided with AISA scan engine 2008, as well as AISA-provided header files proto_cip.h 2012, proto_cpf.h 2014, proto_dnp.h 2016, proto_enip.h 2018, proto_modbus.h 2020, and idsvar.h 2022. (It will be understood that the names of these modules may be different in different embodiments of the present invention.) CIP analyzer 2012 may include, for example, a PROFINET analyser 2024. Centralized packet filter 2014 may also include an OCP Classis/UA/Xi analyzer 2026. Modbus analyzer 2020 may include an ICCP (InterControl Center Protocol) analyzer 2028. It will be understood that this software architecture applies to some embodiments that rely upon the FreeBSD operating system, and that other embodiments relying upon this or other operating systems may have somewhat different architectures, including many that can be derived from FIG. 19 by one skilled in the art.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A non-volatile memory having computer readable instructions configured to instruct a computer or controller to:
run a setup wizard to obtain setup and filtering module configuration rules from a user;
reload the computer or controller with the settings obtained by the setup wizard;
configure filtering module rules including rules for an industrial protocol filter; and
filter received packets in accordance with the filtering module rules.

2. A memory in accordance with claim 1 wherein to filter received packets in accordance with the filtering module rules further comprises said computer readable instructions including instructions to:
receive a packet at an interface;
drop the packet when either:
the packet is not part of an existing permitted filtering module connection and the packet is not allowed by the configured filtering module rules, or
the packet is an industrial protocol filter connection, and the connection does not match a “pass” rule of the industrial protocol rules.

3. A memory in accordance with claim 2 further having computer readable instructions configured to instruct the computer or controller to analyze objects embedded in industrial protocol filter connections to determine whether or not to drop the packet.

4. A memory in accordance with claim 3 further having computer readable instructions to instruct the computer or controller to request instructions from the user relating to whether or not to selectively log packets and to instruct the computer or controller to selectively log packets in accordance with the instructions obtained from the user.

5. A memory in accordance with claim 4 further having computer readable instructions to instruct the computer or controller to reserve a user-selectable amount of computer or controller memory for at least one of a ruleset of filtering module rules, a ruleset of industrial protocol filter rules, or both.

6. A memory in accordance with claim 2 further having computer readable instructions to instruct the computer or controller to request instructions from the user relating to whether or not to selectively log packets and to instruct the computer or controller to selectively log packets in accordance with the instructions obtained from the user.

7. A memory in accordance with claim 6 further having computer readable instructions to instruct the computer or controller to reserve a user-selectable amount of computer or controller memory for at least one of a ruleset of filtering module rules, a ruleset of industrial protocol filter rules, or both.

8. A method of operating an industrial plant that includes a plurality of industrial controllers on a local area network (LAN), said method comprising:
providing an anti-intrusion and security apparatus (AISA) having two or more Ethernet ports, at least a first of which is configured to communicate through a wide area network (WAN), and the other of which is configured to communicate with the LAN;
electrically connecting the first Ethernet port to the WAN and the other Ethernet port to the LAN;
utilizing the AISA to filter packets of data received for ingress at the first Ethernet port in accordance with one or more rules; and
utilizing the AISA to filter packets of data received for egress at the other Ethernet port in accordance with a one or more rules;
wherein said at least one of filtering packets of data received for ingress, filtering packets of data received for egress, or both, further comprise utilizing the AISA to analyze objects embedded in industrial protocol filter connections to determine whether or not to drop the packet.

9. A method in accordance with claim 8 further comprising:
utilizing the AISA to run a setup wizard to obtain setup and filtering module configuration rules from a user;
utilizing the AISA to reload the computer or controller with the settings obtained by the setup wizard;
configuring filtering module rules in the AISA, including rules for an industrial protocol filter; and
utilizing the AISA to filter received packets in accordance with the filtering module rules.

10. A method in accordance with claim 9 wherein to filter received packets in accordance with the filtering module rules further comprises utilizing the AISA to:
receive a packet at an interface, wherein the interface is either the LAN or the WAN port;
drop the packet when either:
the packet is not part of an existing permitted filtering module connection and the packet is not allowed by the configured filtering module rules, or
the packet is an industrial protocol filter connection, and the connection does not match a “pass” rule of the industrial protocol rules.

11. A method in accordance with claim 10 wherein the AISA is further utilized to request instructions from the user relating to whether or not to selectively log packets and to selectively log packets in accordance with the instructions obtained from the user.

12. A method in accordance with claim 10 further comprising instructing the AISA to reserve a user-selectable amount of computer or controller memory for at least one of a ruleset of filtering module rules, a ruleset of industrial protocol filter rules, or both.

13. A method in accordance with claim 8 wherein the AISA is further utilized to request instructions from the user relating to whether or not to selectively log packets and to selectively log packets in accordance with the instructions obtained from the user.

14. An anti-intrusion and security apparatus (AISA) comprising:
a microprocessor or controller (hereinafter, “microprocessor”);
memory communicatively associated with the microprocessor;
one or more filtering modules, not necessarily separate from the memory and the microprocessor;
at least one WAN port interface and a LAN port interface having communication therebetween controlled by the filtering module;
the AISA configured to:
run a setup wizard to obtain setup and filtering module configuration rules from a user;
reload the memory with the settings obtained by the setup wizard;
configure filtering module rules in the memory including rules for an industrial protocol filter; and
filter received packets for communication ingress and egress in accordance with the filtering module rules.

15. An apparatus in accordance with claim 14 wherein said apparatus being configured to filter received packets in accordance with the filtering module rules further comprises the AISA configured to:
receive a packet at least one interface;
drop the received packet when either:
the received packet is not part of an existing permitted filtering module connection and the received packet is not allowed by the configured filtering module rules, or
the received packet is an industrial protocol filter connection, and the connection does not match a “pass” rule of the industrial protocol rules.

16. An apparatus in accordance with claim 15 further configured to analyze objects embedded in industrial protocol filter connections to determine whether or not to drop the packet.

17. An apparatus in accordance with claim 16 further configured to request instructions from the user relating to whether or not to selectively log packets and to instruct the computer or controller to selectively log packets in accordance with the instructions obtained from the user.

18. An apparatus in accordance with claim 17 further configured to reserve a user-selectable amount of the memory for at least one of a ruleset of filtering module rules, a ruleset of industrial protocol filter rules, or both.

19. An apparatus in accordance with claim 15 further configured to request instructions from the user relating to whether or not to selectively log packets and to instruct the computer or controller to selectively log packets in accordance with the instructions obtained from the user.

20. An apparatus in accordance with claim 19 further configured to reserve a user-selectable amount of the memory for at least one of a ruleset of filtering module rules, a ruleset of industrial protocol filter rules, or both.
